(19) United States
(12) Patent Application Publication
(10) Pub. No.: US 2020/0114379 A1
(43) Pub. Date: Apr. 16, 2020

(54) Hose-On Spray

(71) Applicant: IVM IP Pty Ltd, Brisbane (AU)

(72) Inventor: Nicholas Bloor, Brisbane (AU)

(21) Appl. No.: 16/618,670

(22) PCT Filed: Jun. 1, 2018
(86) PCT No.: PCT/AU2018/050539

§ 371 Date: Dec. 2, 2019

(30) Foreign Application Priority Data
Jun. 1, 2017 (AU) 2017902078

(51) Int. Cl. B05B 7/12; B05B 7/04; A01M 21/00; A01C 23/04

(52) U.S. Cl. CPC B05B 7/12; A01C 23/047; A01M 21/00; B05B 7/0408

(57) ABSTRACT

A sprayer for attachment to a hose, the sprayer including an inlet for introducing fluid into the sprayer, an outlet for discharging fluid from the sprayer, a first controller to control the flow of fluid from the inlet to the outlet, a first fluid path located between the first controller and the outlet, a second fluid path located between the first controller and the outlet, the second fluid path fluidly connectable to a container having an active liquid, and a second controller to control the flow of fluid in the second fluid path, wherein in use, when fluid is flowing in the second fluid path, the fluid flow causes the active liquid to enter the second fluid path and exit the sprayer via the outlet.

### FIELD OF INVENTION

The present invention relates to a sprayer. Reference will be made in the specification to the use of the sprayer with respect to a hose. The patent specification describes this use but it is by way of example only and the invention is not limited to this use.

### BACKGROUND OF THE INVENTION

Sprayers for spraying an active liquid containing weedkiller or fertiliser are known. These sprayers attach to a hose and use water pressure to spray the active liquid from a container onto a lawn or plants.

A problem with these known sprayers is that the amount of active liquid being sprayed cannot be easily controlled.

Another problem with these sprayers is that they are disposable and the active liquid in the containers is not easily refillable. Using a concentrate and water mixture to refill the containers can result in an active liquid that, when sprayed onto lawn or plants, is too strong or too weak if the concentrate and water mixture is not properly prepared.

### OBJECT OF THE INVENTION

It is an object of the present invention to overcome or at least alleviate one or more of the above mentioned problems with sprayers and/or provide the consumer with a useful or commercial choice.

### SUMMARY OF THE INVENTION

In one aspect, the present invention broadly resides in a sprayer for attachment to a hose, the sprayer including

an inlet for introducing fluid into the sprayer;

an outlet for discharging fluid from the sprayer;

a first controller to control the flow of fluid from the inlet to the outlet;

a first fluid path located between the first controller and the outlet;

a second fluid path located between the first controller and the outlet, the second fluid path fluidly connectable to a container having an active liquid; and

a second controller to control the flow of fluid in the second fluid path,

wherein in use, when fluid is flowing in the second fluid path, the fluid flow causes the active liquid to enter the second fluid path and exit the sprayer via the outlet.

The fluid is preferably a liquid. More preferably the fluid is water.

The inlet preferably includes a hose coupling. Preferably the hose coupling is attachable to a garden hose. More preferably the hose coupling is attachable to a hose connector of a garden hose.

The outlet preferably includes a nozzle to discharge the fluid. The nozzle preferably sprays the fluid. In one embodiment, the outlet includes a plurality of nozzles. Preferably a desired nozzle is selectable from the plurality of nozzles. The outlet preferably includes a selector ring to select a desired nozzle from the plurality of nozzles. In another embodiment, the outlet includes an adjustable nozzle.

The first controller preferably includes a valve. The first controller preferably includes a trigger. When actuated, the trigger preferably opens the first controller valve. Preferably when the first controller valve is open, at least a portion of the fluid flows through the first fluid path. The trigger is preferably located on a handle of the sprayer.

The first fluid path is preferably a duct. More preferably the first fluid path is a tube.

The second controller preferably includes a valve. The second controller preferably includes a switch. When actuated, the switch preferably opens the second controller valve. Preferably when the second controller is actuated and when the first controller is actuated, at least a portion of the fluid flows through the second fluid path.

The second fluid path is preferably a duct. More preferably the second fluid path is a tube.

The sprayer preferably includes the container. The container is preferably a rigid container. In one embodiment, the container is a collapsible bladder.

The sprayer preferably includes a connector to connect to the container. The connector preferably has a threaded portion which engages with a threaded portion on the container. In one embodiment, the connection between the connector and the container is a cam and groove type connection or similar connection.

The sprayer preferably includes a flow controller to control the rate of flow of active liquid from the container. Preferably the flow controller is in the form of a selector dial. In one embodiment, the flow controller has a plurality of distinct flow settings. Preferably the distinct flow settings range from a low flow rate setting to a high flow rate setting. Preferably the high flow rate setting is at least 100% more than the low flow rate setting. In one embodiment; the flow controller is controlled by the container. Preferably the container operatively engages with the flow controller to control the flow of active liquid from the container. Preferably containers having different active liquids have different arrangements that engage with the flow controller to change the rate at which the active liquid moves from the containers.

The sprayer preferably includes a flow indicator. The flow indicator preferably indicates the flow of active liquid from the container. Preferably the flow indicator is one of a ball, rotor or impeller flow indicator.

The container preferably has a one way opening. The one way opening preferably allows the active liquid to flow from the container and prevents liquid from entering the container. In one embodiment, the one way opening includes a one way valve. In another embodiment, the one way opening includes a one way membrane. In a further embodiment, a venturi arrangement acts as a one way opening.

Preferably when fluid is flowing in the second fluid path, the fluid flow causes a reduction in fluid pressure, drawing the active liquid from the container. Preferably the active liquid from the container is drawn into the fluid flow in the second fluid path and is discharged from the outlet. In one embodiment, the second fluid path has a venturi arrangement.

Preferably the sprayer includes a pressure reduction valve to regulate the pressure of fluid being introduced via the inlet.

Preferably the sprayer includes a one way valve to prevent active liquid from flowing to the inlet.

In another aspect, the present invention broadly resides in a sprayer including

an inlet for introducing fluid into the sprayer;

an outlet for discharging fluid from the sprayer;

a first controller to control the flow of fluid from the inlet to the outlet;

a first fluid path located between the first controller and the outlet;

a second fluid path located between the first controller and the outlet, the second fluid path fluidly connectable to a container having an active liquid; and

a second controller to control the flow of fluid in the second fluid path,

wherein in use, when fluid is flowing in the second fluid path, the fluid flow in the second fluid path causes the active liquid to exit the sprayer via the outlet.

In a further aspect, the present invention broadly resides in a method of spraying an active liquid using a sprayer as disclosed in this specification, the method including the steps of

introducing fluid into the sprayer via the inlet;

actuating the first controller to allow at least a portion of the fluid to flow through the first fluid path;

actuating the second controller to allow a portion of the fluid to flow through the second fluid path; and

using the fluid flow in the second fluid path to move active liquid from the container and discharge the active liquid from the outlet.

Preferably the method further includes the step of using the flow controller to control the rate of flow of active liquid from the container.

Preferably the method further includes the step of indicating the flow of active liquid from the container using a flow indicator.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a schematic side view of a sprayer according to a preferred embodiment of the present invention;

FIG. 2 is a schematic side view of the sprayer of FIG. 1 with a container attached;

FIG. 3 is a top view of the sprayer of FIG. 3;

FIG. 4 is a schematic side view of a sprayer according to a second preferred embodiment of the present invention; and

FIG. 5 is a top view of the sprayer of FIG. 4.

### DETAILED DESCRIPTION OF THE PREFERRED EMBODIMENT

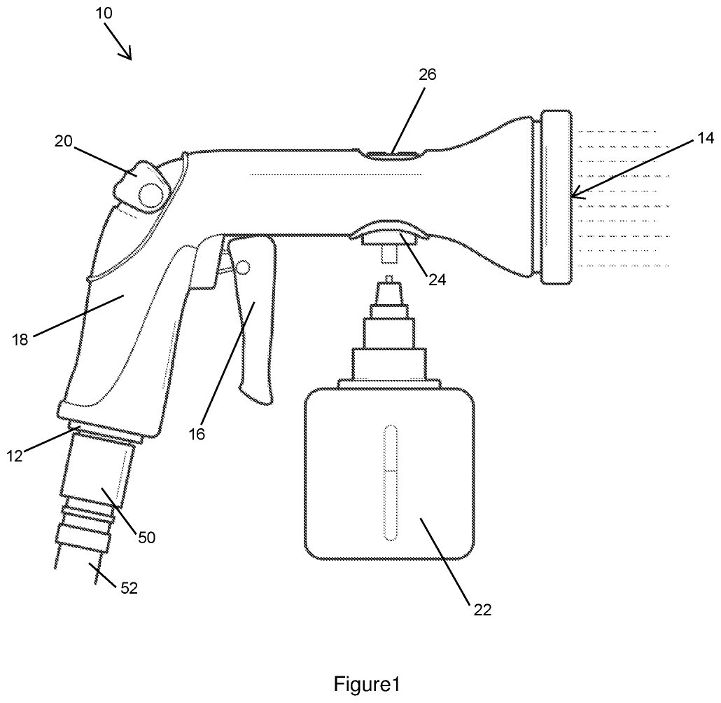

With reference to FIGS. 1 to 3, there is shown a sprayer 10 according to a preferred embodiment of the present invention. The sprayer 10 has an inlet in the form of a hose coupling 12 and an outlet in the form of a nozzle 14. The sprayer has a first controller in the form of a trigger 16, which controls the flow of water from the hose coupling 12 to the nozzle 14. The trigger 16 is located on a handle 18 of the sprayer 10. The hose coupling 12 is attachable to a hose connector 50 of a garden hose 52 which provides flowing water.

The sprayer 10 has a first fluid path in the form of a tube (not shown) located between the trigger 16 and the nozzle 14. When the trigger 16 is actuated, at least a portion of the water can flow from the hose coupling 12 to the nozzle 14.

The sprayer 10 has a second fluid path in the form of a tube (not shown) located between the trigger 16 and the nozzle 14. A second controller in the form of a thumb switch 20 controls the flow of water in the second fluid path.

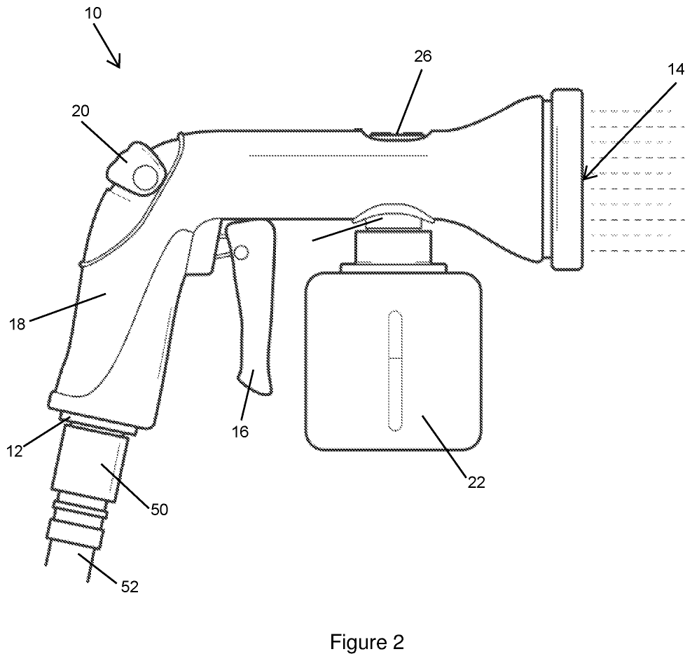

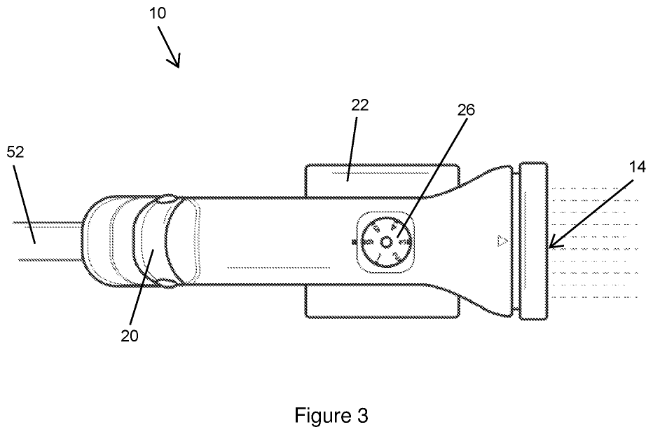

The sprayer 10 has a container 22 which is attachable to the sprayer via a connector 24. When the container 24 is connected to the sprayer 10 (as seen in FIGS. 2 and 3), the container 24 is fluidly connected to the second fluid path (not shown). The container 24 contains an active liquid such as a fertiliser or weedkiller.

When the trigger 16 is actuated and the thumb switch 20 is actuated, water flows in the second fluid path (not shown) and through a venturi arrangement (not shown) draws the active liquid from the container 24 into the second fluid path and the water flow in the second fluid path discharges the active liquid from the nozzle 14.

When the trigger 16 is actuated but the thumb switch 20 is not actuated, water only flows through the first fluid path and discharges from the nozzle 14. In this manner, a user (not shown) can choose between discharging just water or discharging water mixed with active liquid.

The sprayer 10 has a flow controller in the form of a selector dial 26. The selector dial 26 has six distinct settings, allowing a user to choose between six different flow rates of active liquid from the container 22.

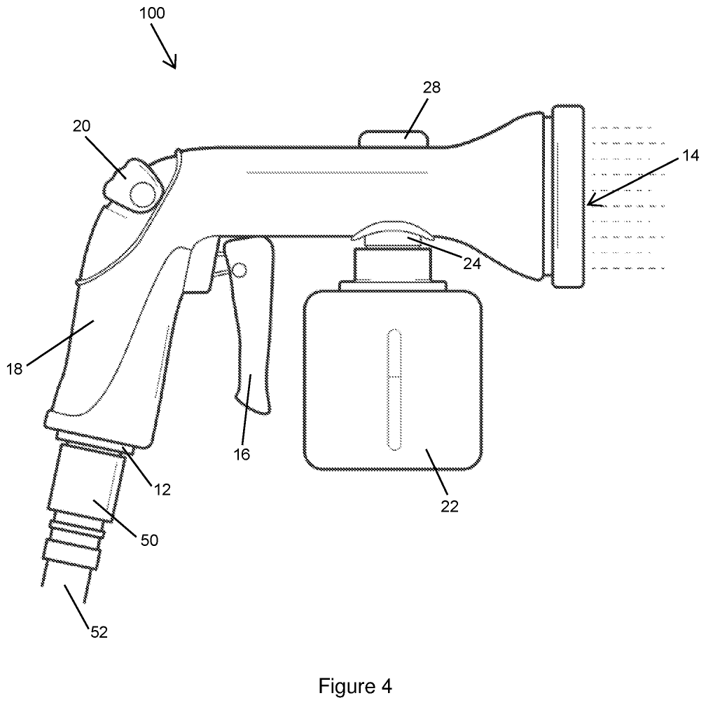

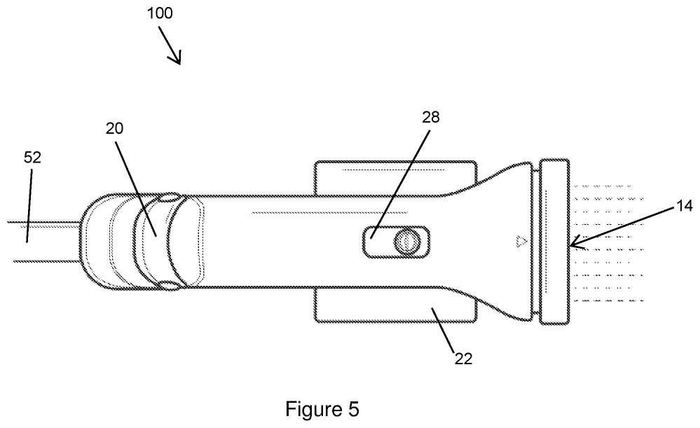

With reference to FIGS. 4 and 5 there is shown a sprayer 100 according to a second preferred embodiment of the invention. The sprayer 100 is similar to the sprayer 10 shown in FIGS. 1 to 3 and the same numbering has been adopted for the similar parts. The difference between the sprayer 100 and the sprayer 10 is that the sprayer 100 does not have a selector dial 26 (as seen in FIGS. 1 to 3). The sprayer 100 additionally has a flow indicator in the form of a ball flow indicator 28 which indicates the flow of active liquid from the container 22.

### Advantages

An advantage of the preferred embodiment of the sprayer includes an easier way to control the discharge of active liquid from the sprayer. Another advantage of the preferred embodiment of the sprayer includes the ability to spray water without the addition of active liquid. A further advantage of the preferred embodiment of the sprayer includes the ability to switch to different types of active liquids.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A sprayer for attachment to a hose, the sprayer comprising
an inlet for introducing fluid into the sprayer;
an outlet for discharging fluid from the sprayer;
a first controller to control the flow of fluid from the inlet to the outlet;
a first fluid path located between the first controller and the outlet;
a second fluid path located between the first controller and the outlet, the second fluid path fluidly connectable to a container having an active liquid; and
a second controller to control the flow of fluid in the second fluid path,
wherein in use, when fluid is flowing in the second fluid path, the fluid flow causes the active liquid to enter the second fluid path and exit the sprayer via the outlet.

2. A sprayer comprising
an inlet for introducing fluid into the sprayer;
an outlet for discharging fluid from the sprayer;
a first controller to control the flow of fluid from the inlet to the outlet;
a first fluid path located between the first controller and the outlet;
a second fluid path located between the first controller and the outlet, the second fluid path fluidly connectable to a container having an active liquid; and
a second controller to control the flow of fluid in the second fluid path,
wherein in use, when fluid is flowing in the second fluid path, the fluid flow in the second fluid path causes the active liquid to exit the sprayer via the outlet.

3. The sprayer as claimed in claim 1, wherein the inlet includes a hose coupling attachable to a garden hose.

4. The sprayer as claimed in claim 1, wherein the outlet includes a nozzle to discharge the fluid.

5. The sprayer as claimed in claim 1, wherein the outlet includes a plurality of nozzles, and a desired nozzle is selectable from the plurality of nozzles.

6. The sprayer as claimed in claim 5, wherein the outlet includes a selector ring to select the desired nozzle from the plurality of nozzles.

7. The sprayer as claimed in claim 1, wherein the first controller includes a valve and a trigger, when actuated, the trigger opens the first controller valve.

8. The sprayer as claimed in claim 1, wherein the second controller includes a valve and a switch, when actuated, the switch opens the second controller valve.

9. The sprayer as claimed in claim 1, including the container.

10. The sprayer as claimed in claim 9, wherein the container is a rigid container.

11. The sprayer as claimed in claim 9, wherein the container is a collapsible bladder.

12. The sprayer as claimed in claim 1, including a flow controller to control the rate of flow of active liquid from the container.

13. The sprayer as claimed in claim 12, wherein the flow controller has a plurality of distinct flow settings.

14. The sprayer as claimed in claim 12, wherein the container operatively engages with the flow controller to control the flow of active liquid from the container.

15. The sprayer as claimed in claim 1, including a flow indicator to indicate the flow of active liquid from the container.

16. The sprayer as claimed in claim 1, wherein the second fluid path has a venturi arrangement, and wherein when fluid is flowing in the second fluid path, the fluid flow and the venturi arrangement causes a reduction in fluid pressure, drawing the active liquid from the container, the active liquid from the container is drawn into the fluid flow in the second fluid path and is discharged from the outlet.

17. The sprayer as claimed in claim 1, wherein the fluid is water.

18. The method of spraying an active liquid using a sprayer as claimed in claim 1, the method the steps of
introducing fluid into the sprayer via the inlet;
actuating the first controller to allow at least a portion of the fluid to flow through the first fluid path;
actuating the second controller to allow a portion of the fluid to flow through the second fluid path; and
using the fluid flow in the second fluid path to move active liquid from the container and discharge the active liquid from the outlet.

19. The method as claimed in claim 18 further including the step of using a flow controller to control the rate of flow of active liquid from the container.

20. The method as claimed in claim 18 further including the step of indicating the flow of active liquid from the container using a flow indicator.
